(19) United States
(12) Patent Application Publication
(10) Pub. No.: US 2011/0189465 A1
(43) Pub. Date: Aug. 4, 2011

(54) PROCESS FOR MANUFACTURING A SHAPED FOAM COMPOSITE ARTICLE

(76) Inventors: Myron Maurer, Saginaw, MI (US); Tinothy J. Pope, Freeland, MI (US); Paul Vantol, Essexville, MI (US); Gavin D. Vogel, Warren, MI (US); Claude Brown, JR., Saginaw, MI (US)

(21) Appl. No.: 13/055,159

(22) PCT Filed: Jul. 9, 2009
(86) PCT No.: PCT/US09/49995

§ 371 Date: Jan. 21, 2011

Related U.S. Application Data
(60) Provisional application No. 61/083,216, filed on Jul. 24, 2008.

(51) Int. Cl. B32B 3/26; B29C 51/10; B32B 38/18

(52) U.S. Cl. 428/304.4; 156/212; 156/214; 156/78

(57) ABSTRACT

The present invention is a method to manufacture shaped foam composite articles and articles made therefrom. Specifically, shaped foam articles having a laminated skin such as a solid thermoplastic sheet. The shaped foam article (10) and the skin may be made from the same or different materials. The method comprises (i) preparing a shaped foamed article with a plurality of perforations and (ii) vacuum forming a skin onto the perforated shaped foamed article.

### CROSS REFERENCE STATEMENT

This application claims the benefit of U.S. Provisional Application No. 61/083,216, filed Jul. 24, 2008.

### BACKGROUND OF THE INVENTION

The present invention is a method to manufacture shaped foam composite articles, specifically, shaped foam articles having a laminated skin such as a solid thermoplastic sheet. The shaped foam article and the skin may be made from the same or different materials.

Foam composite articles can be used for doors, wash basins, shower and bath surrounds, refrigerator and freezer panes, surfboards, pallets, doors, transformer mounting pads, automotive articles, and the like. Foam composite articles demonstrate many advantages compared to counterparts that are solely foamed or solely solid. For instance, a foam composite article may demonstrate better blend of performance properties at a lighter weight and/or a lower cost to manufacture.

One approach to a foam composite article is structural foam molding providing an article with a high density shell and an integral lower density core, see U.S. Pat. No. 3,268,636. However, articles produced by this process have essentially the same chemical and visual characteristics throughout their cross-section, so that the high density shell will have properties very similar to that of the lower density core.

Various methods to form foamed composite articles wherein the foamed article and the laminated surface may comprise different materials are known. For instance, U.S. Pat. No. 2,806,812 discloses a method for the preparation of a planar foam composite article comprising thermoplastic sheets having a resin foam integrally bonded thereto. These sheets are made by preparing a mold assembly into which foamable resin beads are placed, after which the beads are foamed, a sheet of thermoplastic resin is applied to the top surface of the mold cavity containing the foamed beads, and atmospheric pressure is used to force the thermoplastic sheet into pressured engagement with the face of the resin foam.

U.S. Pat. No. 4,350,730 discloses a process to produce a planar foamed composite article wherein two solid thermoplastic sheets are fusion bonded to a foam resin core.

U.S. Pat. No. 4,944,416 discloses a method to make a planar foamed composite article wherein polymeric beads are expanded then compressed to a desired density to form a foamed core and then skins, such as FORMICA or plastic sheets, are adhesively bonded to the foamed core. This process is limited to planar articles and the procedures are described as expensive and time consuming.

U.S. Pat. No. 5,401,456 discloses a pallet made by first forming a substantially flat foamed core which is placed between vacuum formed top and bottom sheets. However, this method requires preforming the skins and a very specialized molding apparatus comprising, among other things, a carousel mechanism.

U.S. Pat. No. 3,090,078 discloses a process for foaming or expanding a resin between a pair of skin surfaces in situ. However, this method is limited to planar applications wherein the expandable resins are of the type employing water vapor for blowing purposes.

U.S. Pat. No. 3,910,747 discloses a multi-step method to form a shaped foamed composite article within a thermoforming or vacuum forming machine by first thermoforming or vacuum forming an upper and lower thermoplastic sheets on their respective die faces and then inserting a preformed foamed article between the formed upper and lower sheets before the press closes. This method has the disadvantage that it requires multiple steps including preforming the skins.

U.S. Pat. No. 4,053,545 discloses a method for forming shaped foamed composite plastic devices by thermoforming a thermoplastic sheet to the general outer contour of a desired article. Then placing the thermoformed thermoplastic sheet within a cavity of a heated mold and injecting the cavity with foamable polymer. However, this process is a multi-step, multi-mold process requiring a long cycle time because of the necessity to heat the final mold.

U.S. Pat. No. 5,811,039 discloses a process for fabricating shaped foamed composite articles of thermoplastic material including a foamed core bonded to a compatible thermoplastic sheet. A sheet of thermoplastic material is first preheated and then vacuum formed on a first half-mold. The first half-mold with the thermoformed sheet is positioned opposite a second half-mold to form a hollow chamber therebetween. A foamable thermoplastic material containing one or more liquid hydrocarbons is injected into the hollow space at a temperature sufficiently high to permit the foamable material to expand and bond to the thermoformed sheet. However, complex equipment is required for such a process. Further, the shaped foamed article is limited to having a thermoplastic sheet on only one surface.

U.S. Pat. No. 6,401,414 discloses a process to make a planar foamed composite, such as a door, wherein thermoplastic skins are vacuum formed then adhesively bonded to a rigid foam core having frangible cells, wherein said cells are capable of conforming to depressed zones in the vacuum formed skins by crumbling under compression. This process requires multi-steps, is time consuming, and is limited to planar articles.

In addition to producing skins, or half shells, by thermoforming or vacuum forming, foamed composite articles may by fabricated by blow molding or injection molding, two half-shells which are assembled with each other by gluing or welding; the hollow chamber comprised between both half-shells is then filled with foam, such as foamed polyurethane by the well known reaction injection molding (RIM) technology.

These patents are illustrative of the varied techniques in the prior art to manufacture foamed composite articles. However, they suffer from a variety of drawbacks. It would be desirable to have a simple, cost effective method to make a foam composite article in which the article preferably can be, but is not limited to being shaped and the skins can be a different material than the foam core and the process does not require combinations of expensive and/or complex equipment, multiple steps, multiple molds, and/or adhesives to bond the skin(s) to the foam core.

### SUMMARY OF THE INVENTION

The present invention is such a simple, cost effective method to make foam composite articles, preferably a shaped foam composite article. The foam composite articles of the present invention eliminate the need for complex equipment, multiple molds, and long cycle times.

In one embodiment, the present invention is a method to manufacture a shaped foam composite article comprising the steps of (i) preparing a foamed article comprising a plurality of perforations and (ii) vacuum forming a skin onto the perforated foamed article.

In another embodiment, the method of the present invention further comprises the steps of (i)(a) producing a foam sheet, (i)(b) perforating the foam sheet, and (i)(c) shaping the perforated foam sheet, preferably the perforated sheet is shaped by wire cutting, hot wire cutting, die cutting, water jet cutting, milling, match mold thermoforming, continuous role forming, compression, or a combination thereof.

An alternative embodiment of the method of the present invention further comprises the steps of (i)(a) producing a foam sheet, (i)(d) shaping the foam sheet, and (i)(e) perforating the shaped foam sheet, preferably the shaped foam sheet is shaped by wire cutting, hot wire cutting, die cutting, water jet cutting, milling, match mold thermoforming, continuous role forming, compression, or a combination thereof.

In a preferred embodiment of the method of the present invention the foam sheet (i)(a) comprises a foamed thermoset polymer, preferably prepared by RIM, more preferably the foam sheet (i)(a) comprises a foamed thermoplastic polymer prepared by an expanded bead foam process or more preferably by extrusion using a chemical blowing agent, an inorganic gas, an organic blowing agent, or combinations thereof, wherein the thermoplastic polymer is preferably polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

In another embodiment of the method of the present invention the skin is a thermoplastic sheet, thermoset sheet, a metal film, wood venire, cloth, fiber mat, leather, or combinations thereof.

In another embodiment of the method of the present invention the thermoplastic sheet skin comprises polystyrene; high impact polystyrene; styrene and acrylonitrile copolymer; acrylonitrile, butadiene, and styrene terpolymer; polyphenyleneoxide; polycarbonate; polyethylene terephthalate; polybutylene terephthalate; copolymers of PE with a C₃ to C₂₀ alpha-olefin, high density polyethylene, low density polyethylene, linear low density polyethylene, substantially linear ethylene polymer, linear ethylene polymer; polypropylene homopolymer; random copolymer of polypropylene; block copolymer of polypropylene; copolymer of propylene with a C₄ to C₂₀ alpha-olefin; thermoplastic polyolefin; olefinic thermoplastic elastomer; chlorinated polyethylene; polyvinyl chloride; polytetrafluoroethane; polyurethane; thermoplastic polyurethane; polyacrylic acid; polybutyl acrylate; polymethacrylate; polymethyl methacrylate; polyamide; and blends thereof.

In another embodiment of the method of the present invention the skin adheres to the shaped foam article by thermal means, mechanical means, physical means, chemical means, adhesive means, or combinations thereof.

Another embodiment of the present invention is a shaped foam composite article made by the method disclosed hereinabove.

### BRIEF DESCRIPTION OF THE DRAWINGS

FIG. 1 is an illustration of the step change in the shaped foam article of this invention.

FIG. 2 is a photograph of a first forming tool used to form a shaped foam article of this invention.

FIG. 3 is a photograph of a second forming tool used to form a shaped foam article of this invention.

FIG. 4 is a photograph of a first shaped foam article made using a method of this invention.

FIG. 5 is a photograph of a second shaped foam article made using a method of this invention.

FIG. 6 is a photograph of a shaped foam composite article made using a method of this invention.

### DETAILED DESCRIPTION OF THE INVENTION

The foamed article of the present invention can be made from any foam composition. A foam composition comprises a continuous matrix material with cells defined therein. Cellular (foam) has the meaning commonly understood in the art in which a polymer has a substantially lowered apparent density comprised of cells that are closed or open. Closed cell means that the gas within that cell is isolated from another cell by the polymer walls forming the cell. Open cell means that the gas in that cell is not so restricted and is able to flow without passing through any polymer cell walls to the atmosphere. The foam article of the present invention can be open or closed celled. A closed cell foam has less than 30 percent, preferably 20 percent or less, more preferably 10 percent or less and still more preferably 5 percent or less and most preferably one percent or less open cell content. A closed cell foam can have zero percent open cell content. Conversely, an open cell foam has 30 percent or more, preferably 50 percent or more, still more preferably 70 percent or more, yet more preferably 90 percent or more open cell content. An open cell foam can have 95 percent or more and even 100 percent open cell content. Unless otherwise noted, open cell content is determined according to American Society for Testing and Materials (ASTM) method D6226-05.

Desirably the foam article comprises polymeric foam, which is a foam composition with a polymeric continuous matrix material (polymer matrix material). Any polymeric foam is suitable including extruded polymeric foam, expanded polymeric foam and molded polymeric foam. The polymeric foam can comprise, and desirably comprises as a continuous phase, a thermoplastic or a thermoset polymer matrix material. Desirably, the polymer matrix material has a thermoplastic polymer continuous phase.

A polymeric foam article for use in the present invention can comprise or consist of one or more thermoset polymer, thermoplastic polymer, or combinations or blends thereof. Suitable thermoset polymers include thermoset epoxy foams, phenolic foams, urea-formaldehyde foams, polyurethane foams, and the like.

Suitable thermoplastic polymers include any one or any combination of more than one thermoplastic polymer. Olefinic polymers, alkenyl-aromatic homopolymers and copolymers comprising both olefinic and alkenyl aromatic components are suitable. Examples of suitable olefinic polymers include homopolymers and copolymers of ethylene and propylene (e.g., polyethylene, polypropylene, and copolymers of polyethylene and polypropylene). Alkenyl-aromatic polymers such as polystyrene and polyphenylene oxide/polystyrene blends are particularly suitable polymers for of the foam article to the present invention.

Desirably, the foam article comprises a polymeric foam having a polymer matrix comprising or consisting of one or more than one alkenyl-aromatic polymer. An alkenyl-aromatic polymer is a polymer containing alkenyl aromatic monomers polymerized into the polymer structure. Alkenyl-aromatic polymer can be homopolymers, copolymers or blends of homopolymers and copolymers. Alkenyl-aromatic copolymers can be random copolymers, alternating copolymers, block copolymers, rubber modified, or any combination thereof and my be linear, branched or a mixture thereof.

Styrenic polymers are particularly desirably alkenyl-aromatic polymers. Styrenic polymers have styrene and/or substituted styrene monomer (e.g., alpha methyl styrene) polymerized in the polymer backbone and include both styrene homopolymer, copolymer and blends thereof. Polystyrene and high impact modified polystyrene are two preferred styrenic polymers.

Examples of styrenic copolymers suitable for the present invention include copolymers of styrene with one or more of the following: acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene.

Polystyrene (PS) is a preferred styrenic polymer for use in the foam articles of the present invention because of their good balance between cost property performance.

Styrene-acrylonitrile copolymer (SAN) is a particularly desirable alkenyl-aromatic polymer for use in the foam articles of the present invention because of its ease of manufacture and monomer availability. SAN copolymer can be a block copolymer or a random copolymer, and can be linear or branched. SAN provides a higher water solubility than polystyrene homopolymer, thereby facilitating use of an aqueous blowing agent. SAN also has higher heat distortion temperature than polystyrene homopolymer, which provides for a foam having a higher use temperature than a polystyrene homopolymer foam. Desirable embodiments of the present process employ polymer compositions that comprise, even consist of SAN. The one or more alkenyl-aromatic polymer, even the polymer composition itself may comprise or consist of a polymer blend of SAN with another polymer such as polystyrene homopolymer.

Whether the polymer composition contains only SAN, or SAN with other polymers, the acrylonitrile (AN) component of the SAN is desirably present at a concentration of 1 weight percent or more, preferably 5 weight percent or more, more preferably 10 weight percent or more based on the weight of all polymers in the polymer composition. The AN component of the SAN is desirably present at a concentration of 50 weight percent or less, typically 30 weight percent or less based on the weight of all polymers in the polymer composition. When AN is present at a concentration of less than 1 weight percent, the water solubility improvement is minimal over polystyrene unless another hydrophilic component is present. When AN is present at a concentration greater than 50 weight percent, the polymer composition tends to suffer from thermal instability while in a melt phase in an extruder.

The styrenic polymer may be of any useful weight average molecular weight (MW). Illustratively, the molecular weight of a styrenic polymer or styrenic copolymer may be from 10,000 to 1,000,000. The molecular weight of a styrenic polymer is desirably less than about 200,000, which surprisingly aids in forming a shaped foam part retaining excellent surface finish and dimensional control. In ascending further preference, the molecular weight of a styrenic polymer or styrenic copolymer is less than about 190,000, 180,000, 175,000, 170,000, 165,000, 160,000, 155,000, 150,000, 145,000, 140,000, 135,000, 130,000, 125,000, 120,000, 115,000, 110,000, 105,000, 100,000, 95,000, and 90,000. For clarity, molecular weight herein is reported as weight average molecular weight unless explicitly stated otherwise. The molecular weight may be determined by any suitable method such as those known in the art.

Rubber modified homopolymers and copolymers of styrenic polymers are preferred styrenic polymers for use in the foam articles of the present invention, particularly when improved impact is desired. Such polymers include the rubber modified homopolymers and copolymers of styrene or alpha-methylstyrene with a copolymerizable comonomer. Preferred comonomers include acrylonitrile which may be employed alone or in combination with other comonomers particularly methylmethacrylate, methacrylonitrile, fumaronitrile and/or an N-arylmaleimide such as N-phenylmaleimide. Highly preferred copolymers contain from about 70 to about 80 percent styrene monomer and 30 to 20 percent acrylonitrile monomer.

Suitable rubbers include the well known homopolymers and copolymers of conjugated dienes, particularly butadiene, as well as other rubbery polymers such as olefin polymers, particularly copolymers of ethylene, propylene and optionally a nonconjugated diene, or acrylate rubbers, particularly homopolymers and copolymers of alkyl acrylates having from 4 to 6 carbons in the alkyl group. In addition, mixtures of the foregoing rubbery polymers may be employed if desired. Preferred rubbers are homopolymers of butadiene and copolymers thereof in an amount equal to or greater than about 5 weight percent, preferably equal to or greater than about 7 weight percent, more preferably equal to or greater than about 10 weight percent and even more preferably equal to or greater than 12 weight percent based on the total weight or the rubber modified styrenic polymer. Preferred rubbers present in an amount equal to or less than about 30 weight percent, preferably equal to or less than about 25 weight percent, more preferably equal to or less than about 20 weight percent and even more preferably equal to or less than 15 weight percent based on the total weight or the rubber modified styrenic polymer. Such rubber copolymers may be random or block copolymers and in addition may be hydrogenated to remove residual unsaturation.

The rubber modified homopolymers or copolymers are preferably prepared by a graft generating process such as by a bulk or solution polymerization or an emulsion polymerization of the copolymer in the presence of the rubbery polymer. Depending on the desired properties of the foam article, the rubbers' particle size may be large (for example greater than 2 micron) or small (for example less than 2 micron) and may be a monomodal average size or multimodal, i.e., mixtures of different size rubber particle sizes, for instance a mixture of large and small rubber particles. In the rubber grafting process various amounts of an ungrafted matrix of the homopolymer or copolymer are also formed. In the solution or bulk polymerization of a rubber modified (co)polymer of a vinyl aromatic monomer, a matrix (co)polymer is formed. The matrix further contains rubber particles having (co)polymer grafted thereto and occluded therein.

High impact poly styrene (HIPS) is a particularly desirable rubber-modified alkenyl-aromatic homopolymer for use in the foam articles of the present invention because of its good blend of cost and performance properties, requiring improved impact strength.

Butadiene, acrylonitrile, and styrene (ABS) terpolymer is a particularly desirable rubber-modified alkenyl-aromatic copolymer for use in the foam articles of the present invention because of its good blend of cost and performance properties, requiring improved impact strength and improved thermal properties.

Foam articles for use in the present invention may be prepared by any conceivable method. Suitable methods for preparing polymeric foam articles include batch processes (such as expanded bead foam processes), semi-batch processes (such as accumulative extrusion processes) and continuous processes such as extrusion foam processes. Desirably, the process is a semi-batch or continuous extrusion process. Most preferably process comprises an extrusion process.

An expanded bead foam process is a batch process that requires preparing a foamable polymer composition by incorporating a blowing agent into granules of polymer composition (for example, imbibing granules of a thermoplastic polymer composition with a blowing agent under pressure). Each bead becomes a foamable polymer composition. Often, though not necessarily, the foamable beads undergo at least two expansion steps. An initial expansion occurs by heating the granules above their softening temperature and allowing the blowing agent to expand the beads. A second expansion is often done with multiple beads in a mold and then exposing the beads to steam to further expand them and fuse them together. A bonding agent is commonly coated on the beads before the second expansion to facilitate bonding of the beads together. The resulting expanded bead foam has a characteristic continuous network of polymer skins throughout the foam. The polymer skin network corresponds to the surface of each individual bead and encompasses groups of cells throughout the foam. The network is of higher density than the portion of foam containing groups of cells that the network encompasses. Accumulative extrusion and extrusion processes produce foams that are free of such a polymer skin network.

The foamed article can also be made in a reactive foaming process, in which precursor materials react in the presence of a blowing agent to form a cellular polymer. Polymers of this type are most commonly polyurethane and polyepoxides, especially structural polyurethane foams as described, for example, in U.S. Pat. Nos. 5,234,965 and 6,423,755, both hereby incorporated by reference. Typically, anisotropic characteristics are imparted to such foams by constraining the expanding reaction mixture in at least one direction while allowing it to expand freely or nearly freely in at least one orthogonal direction.

An extrusion process prepares a foamable polymer composition of a thermoplastic polymer with a blowing agent in an extruder by heating a thermoplastic polymer composition to soften it, mixing a blowing agent composition together with the softened thermoplastic polymer composition at a mixing temperature and mixing pressure that precludes expansion of the blowing agent to any meaningful extent (preferably, that precludes any blowing agent expansion) and then extruding (expelling) the foamable polymer composition through a die into an environment having a temperature and pressure below the mixing temperature and pressure. Upon expelling the foamable polymer composition into the lower pressure the blowing agent expands the thermoplastic polymer into a thermoplastic polymer foam. Desirably, the foamable polymer composition is cooled after mixing and prior to expelling it through the die. In a continuous process, the foamable polymer composition is expelled at an essentially constant rate into the lower pressure to enable essentially continuous foaming. An extruded foam can be a continuous, seamless structure, such as a sheet or profile, as opposed to a bead foam structure or other composition comprising multiple individual foams that are assembled together in order to maximize structural integrity and thermal insulating capability.

Accumulative extrusion is a semi-continuous extrusion process that comprises: 1) mixing a thermoplastic material and a blowing agent composition to form a foamable polymer composition; 2) extruding the foamable polymer composition into a holding zone maintained at a temperature and pressure which does not allow the foamable polymer composition to foam; the holding zone having a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand to form the foam. U.S. Pat. No. 4,323,528, hereby incorporated by reference, discloses such a process in a context of making polyolefin foams, yet which is readily adaptable to aromatic polymer foam. U.S. Pat. No. 3,268,636 discloses the process when it takes place in an injection molding machine and the thermoplastic with blowing agent is injected into a mold and allowed to foam, this process is sometimes called structural foam molding.

Suitable blowing agents include one or any combination of more than one of the following: inorganic gases such as carbon dioxide, argon, nitrogen, and air; organic blowing agents such as water, aliphatic and cyclic hydrocarbons having from one to nine carbons including methane, ethane, propane, n-butane, isobutane, n-pentane, isopentane, neopentane, cyclobutane, and cyclopentane; fully and partially halogenated alkanes and alkenes having from one to five carbons, preferably that are chlorine-free (e.g., difluoromethane (HFC-32), perfluoromethane, ethyl fluoride (HFC-161), 1,1,-difluoroethane (HFC-152a), 1,1,1-trifluoroethane (HFC-143a), 1,1,2,2-tetrafluoroethane (HFC-134), 1,1,1,2 tetrafluoroethane (HFC-134a), pentafluoroethane (HFC-125), perfluoroethane, 2,2-difluoropropane (HFC-272fb), 1,1,1-trifluoropropane (HFC-263fb), 1,1,1,2,3,3,3-heptafluoropropane (HFC-227ea), 1,1,1,3,3-pentafluoropropane (HFC-245fa), and 1,1,1,3,3-pentafluorobutane (HFC-365mfc)); fully and partially halogenated polymers and copolymers, desirably fluorinated polymers and copolymers, even more preferably chlorine-free fluorintated polymers and copolymers; aliphatic alcohols having from one to five carbons such as methanol, ethanol, n-propanol, and isopropanol; carbonyl containing compounds such as acetone, 2-butanone, and acetaldehyde; ether containing compounds such as dimethyl ether, diethyl ether, methyl ethyl ether; carboxylate compounds such as methyl formate, methyl acetate, ethyl acetate; carboxylic acid and chemical blowing agents such as azodicarbonamide, azodiisobutyronitrile, benzenesulfo-hydrazide, 4,4-oxybenzene sulfonyl semi-carbazide, p-toluene sulfonyl semi-carbazide, barium azodicarboxylate, N,N′-dimethyl-N,N′-dinitrosoterephthalamide, trihydrazino triazine and sodium bicarbonate.

The amount of blowing agent can be determined by one of ordinary skill in the art without undue experimentation for a given thermoplastic to be foamed based on the type thermoplastic polymer, the type of blowing agent, the shape/configuration of the foam article, and the desired foam density. Generally, the foam article may have a density of from about 16 kilograms per cubic meter (kg/m³) to about 200 kg/m³ or more. The foam density, typically, is selected depending on the particular application. Preferably the foam density is equal to or less than about 160 kg/m³, more preferably equal to or less than about 120 kg/m³, and most preferably equal to or less than about 100 kg/m³.

The cells of the foam article may have an average size (largest dimension) of from about 0.05 to about 5.0 millimeter (mm), especially from about 0.1 to about 3.0 mm, as measured by ASTM D-3576-98. Foam articles having larger average cell sizes, of especially about 1.0 to about 3.0 mm or about 1.0 to about 2.0 mm in the largest dimension, are of particular use when the foam fails to have a compressive ratio of at least 0.4 as described in the following few paragraphs.

In one embodiment of the present invention, to facilitate the shape retention and appearance in the shaped foam article after pressing the shaped foam plank, particularly foams comprising closed cells, it is desirable that the average cell gas pressure is equal to or less than 1.4 atmospheres. In one embodiment, it is desirable that the cell gas pressure is equal to or less than atmospheric pressure to minimize the potential for spring back of the foam after pressing causing less than desirable shape retention. Preferably, the average pressure of the closed cells (i.e., average closed cell gas pressure) is equal to or less than 1 atmosphere, preferably equal to or less than 0.95 atmosphere, more preferably equal to or less than 0.90 atmosphere, even more preferably equal to or less than 0.85 atmosphere, and most preferably equal to or less than 0.80 atmosphere.

Cell gas pressures may be determined from standard cell pressure versus aging curves. Alternatively, cell gas pressure can be determined according to ASTM D7132-05 if the initial time the foam is made is known. If the initial time the foam is made is unknown, then the following alternative empirical method can used: The average internal gas pressure of the closed cells from three samples is determined on cubes of foam measuring approximately 50 mm. One cube is placed in a furnace set to 85° C. under vacuum of at least 1 Torr or less, a second cube is placed in a furnace set to 85° C. at 0.5 atm, and the third cube is placed in the furnace at 85° C. at atmospheric pressure. After 12 hours, each sample is allowed to cool to room temperature in the furnace without changing the pressure in the furnace. After the cube is cool, it is removed from the furnace and the maximum dimensional change in each orthogonal direction is determined. The maximum linear dimensional change is then determined from the measurements and plotted against the pressure and curve fit with a straight line using linear regression analysis with average internal cell pressure being the pressure where the fitted line has zero dimensional change.

The compressive strength of the foam article is established when the compressive strength of the foam is evaluated in three orthogonal directions, E, V and H, where E is the direction of extrusion, V is the direction of vertical expansion after it exits the extrusion die and H is the direction of horizontal expansion of the foam after it exits the extrusion die. These measured compressive strengths, C_{E}, C_{V} and C_{H}, respectively, are related to the sum of these compressive strengths, C_{T}, such that at least one of C_{E}/C_{T}, C_{V}/C_{T} and C_{H}/C_{T}, has a value of at least 0.40, preferably a value of at least 0.45 and most preferably a value of at least 0.50. When using such a foam, the pressing direction is desirably parallel to the maximum value in the foam.

The polymer used to make the foam article of the present invention may contain additives, typically dispersed within the continuous matrix material. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

A most preferred foam article is a shaped foam article which may be prepared from a foamed polymer as described hereinabove and further shaped to give a shaped foam article 10. As defined herein, shaped means the foamed article typically has one or more contour that create a step change (impression) in height 30 of at least 1 millimeter or more in the shaped foam article 10 having thickness 15 as shown in FIG. 1. A shaped article has at least one surface that is not planar.

Shaping a foam article may be accomplished by any means known in the art. For example, the shaped foam article may be foamed in the desired shape, for example by using partially foamed beads of a desired thermoplastic that still have a certain amount of blowing agent and air diffused therein as a result of aging the foam from 12 hours to seven days. The beads are then placed in a mold and heated sufficiently to expand the beads further such that they fill the mold and weld together. For example, foamed polystyrene made this way is typically referred to as expanded polystyrene (EPS) and common examples of EPS foam shaped articles are coffee cups, bike helmets, and the like.

Another process suitable for making a shaped foam article is reaction injection molding (RIM). RIM is a process in which two low molecular weight, highly reactive, low-viscosity liquids are injected at a high pressure into a small mixing chamber and then into a mold cavity. In the mold, the polymerization reaction takes place as the foam shaped article is formed. A preferred two component system comprises one or more polyol and one or more isocyanate to form a polyurethane.

Alternatively, a foam article may be shaped from a foam plank by abrasive wire cutting, hot wire cutting, die cutting, water jet cutting, milling, match mold thermoforming, continuous role forming (sometimes referred to as embossing), or combinations thereof. The use of the term plank, herein, is merely used for convenience with the understanding that configurations other than a flat board having a rectangular cross-section may be extruded and/or foamed (e.g., an extruded sheet, an extruded profile, a pour-in-place bun, etc.). A particularly useful method to shape foam articles is to start from a foam plank which has been extruded from a thermoplastic comprising a blowing agent. As per convention, but not limited by, the extrusion of the plank is taken to be horizontally extruded (the direction of extrusion is orthogonal to the direction of gravity). Using such convention, the plank's top surface is that farthest from the ground and the plank's bottom surface is that closest to the ground, with the height of the foam (thickness) being orthogonal to the ground when being extruded.

The forming of the shaped foam articles is surprisingly enhanced by using foam planks that have at least one direction where at least one of C_{E}/C_{T}, C_{V}/C_{T} and C_{H}/C_{T} is at least 0.4 said one of C_{E}/C_{T}, C_{V}/C_{T} and C_{H}/C_{T} (compressive ratio), C_{E}, C_{V} and C_{H} being the compressive strength of the cellular polymer in each of three orthogonal directions E, V and H where one of these directions is the direction of maximum compressive strength in the foam and C_{T} equals the sum of C_{E}, C_{V} and C_{H}.

After the foam plank is formed, a pressing surface is created, for example by removing a layer from the top or bottom surface or cutting the foam plank between the top and bottom surface to create two pressing surfaces opposite the top and bottom surface. Suitable methods that may be useful are cutting using equipment such as band saws, computer numeric controlled (CNC) abrasive wire cutting machines, CNC hot wire cutting equipment and the like. When removing a layer, the same cutting methods just described may be used and other methods such as planing, grinding or sanding may be used.

Typically, after the removing or cutting, the plank is at least about several millimeters thick to at most about 60 centimeters thick. Generally, when removing a layer, the amount of material is at least about a millimeter and may be any amount useful to perform the method such as 1.2, 1.4, 1.6, 1.8, 2, 2.5, 3, 3.5, 4, 5 millimeters or any subsequent amount determined to be useful such as an amount to remove any skin that is formed as a result of extruding the thermoplastic foam, but is typically no more than 10 millimeters. In another embodiment, the foam is cut and a layer is removed from the top or bottom surface opposite the cut surface to form two pressing surfaces.

In a particular embodiment, the foam plank having a pressing surface, has a density gradient from the pressing surface to the opposite surface of the foam plank. Generally, it is desirable to have a density gradient of at least 5 percent, 10 percent, 15 percent, 25 percent, 30 percent or even 35 percent from the pressing surface to the opposing surface of the foam plank. To illustrate the density gradient, if the density of the foam at the surface (i.e., within a millimeter or two of the surface) is 3.0 pounds per cubic foot (pcf), the density would be for a 10 percent gradient either 2.7 or 3.3 pcf at the center of the foam. Even though the density of the foam at the pressing surface may be less or greater than the density at the center of the foam, the density of the foam at the pressing surface is preferably less than the density at the center of said foam plank Likewise, if the foam plank has two pressing surfaces, both desirably have the aforementioned density gradient.

The plank prior to contacting with a forming tool may be cut to fit into a tool, or may be cut simultaneously, such as in die cutting where the die cutting apparatus is set up such that during the cutting, the shape is simultaneously pressed into the pressing surface, in other words, the foam is compressed into the desired shape. Lastly, the final shape may be cut from the pressed part, for example, the foam plank may be roll pressed to form the shape into the pressing surface and subsequently cut. When cutting the foam, any suitable method may be used, such as those known in the art and those described previously for cutting the foam to form a shaped foam article and/or the pressing surfaces. In addition, methods that involve heat may also be used to cut the foam since the pressed shape has already been formed in the pressing surface.

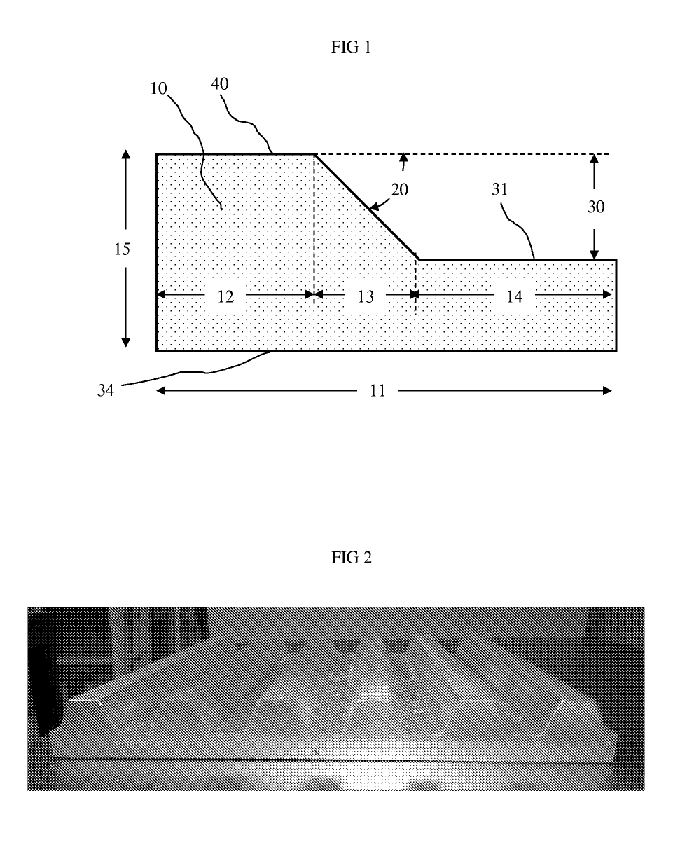

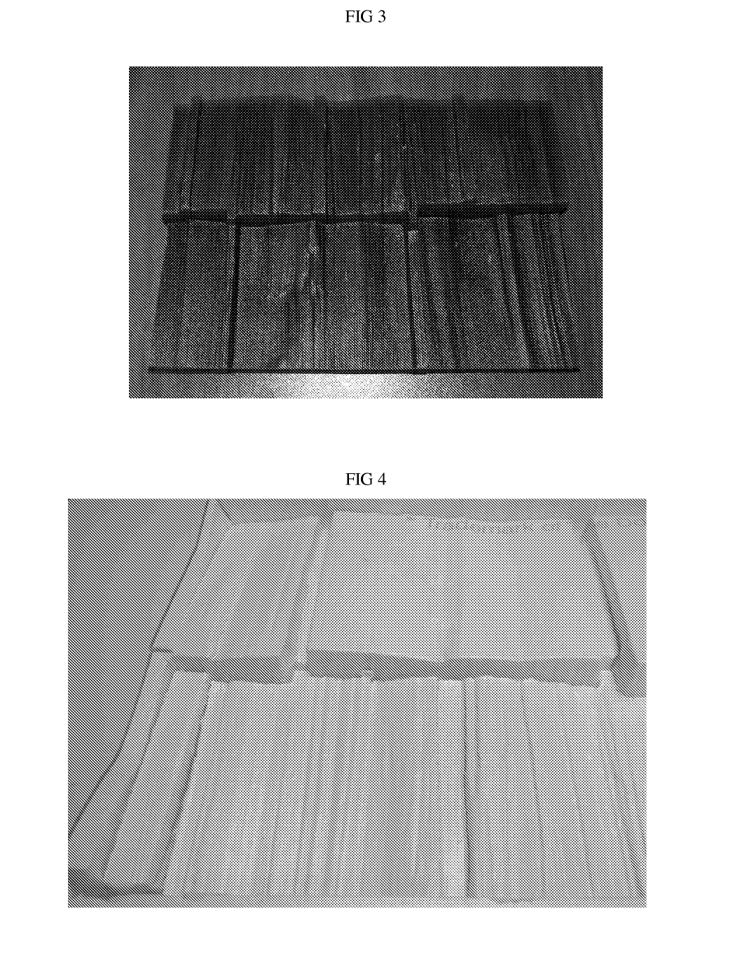

The pressing surface(s) of the plank is contacted with a forming tool such as a die face (for examples see FIGS. 2 and 3). Herein die face means any tool having an impressed shape that when pressed into the foam plank will cause the foam to take the shape of the die face. That is, the material making up the die face is such that it does not deform when pressed against the foam plank, but the foam plank deforms to form and retain the desired shape of the die face.

Typically when pressing, at least a portion of the foam is pressed such that the foam is compressed to a thickness of 95 percent or less of the to be pressed foam thickness (original foam blank thickness) as shown in FIG. 1, which for some foams corresponds to just exceeding the yield stress of the foam. Likewise, when pressing the part, the maximum deformation of the foam (elastically deforming the foam) is typically no more than about 20 percent of the original thickness of the foam ready to be pressed.

The forming tool such as a die face, because a shape is most often desired, typically has contours that create an impression (step change) in height 30 of at least a millimeter in the shaped foam article 10 having thickness 15 as shown in FIG. 1. The height/depth 30 of an impression may be measured using any suitable technique such as contact measurement techniques (e.g., coordinate measuring machines, dial gauges, contour templates) and non-contact techniques such as optical methods including laser methods. The height of the step change 30 may be greater than 1 millimeter such as 1.5, 2, 2.5, 3, 3.5, 4, 5, 6, 7, 8, 9 and 10 millimeters to a height that is to a point where there are no more foam cells to collapse such that pressing further starts to elastically deform the plastic (polymer) of the foam.

The step change, surprisingly, may be formed where the foam undergoes shear. For example, the foam may have a shear angle 20 of about 45° to about 90° from the press surface 40 of the shaped foam article 10 in a step change 30. It is understood that the shear angle may not be linear, but may have some curvature, with the angle in these cases being an average over the curvature. The angle surprisingly may be greater than 60°, 75° or even by 90° while still maintaining an excellent finish and appearance.

In another aspect of the invention, a thermoplastic foam having a higher concentration of open cells at a surface of the foam than the concentration of open cells within the foam is contacted and pressed to form the shape. In this aspect of the invention the foam may be any thermoplastic foam such as the extruded styrenic polymer foam described above. It may also be any other styrenic polymeric foam such as those known in the art including, for example, where the blowing agent is added to polymer beads, typically under pressure, as described by U.S. Pat. No. 4,485,193.

With respect to this open cell gradient, the gradient is as described above for the density gradient where the concentration of open cells if determined microscopically and is the number of open cells per total cells at the surface.

Generally, the amount of open cells in this aspect of the invention at the surface is at least 5 percent to completely open cell. Desirably, the open cells at the surface is at least in ascending order of 6 percent, 7 percent, 8 percent, 10 percent, 20 percent, 30 percent, 40 percent, 50 percent, 60 percent, 70 percent, 80 percent, 90 percent and completely open cell at the surface.

The foam may have the open cells formed at the surface by mechanical means such as those described above (e.g., planing, machining, cutting, etc.) or may be induced chemically, for example, by use of suitable surfactants to burst closed cells at the surface.

The foam surface with the higher concentration of open cells is contacted with a die face and pressed as described above. In a preferred embodiment for such foams, the die faces are heated, but the foam is not (ambient 15-30° C.) and the foam is pressed. Surprisingly, the heated die faces being heated results in superior surface contour and appearance, whereas when doing the same with a foam without such open cells at the surface, the appearance of the foam is degraded.

When pressing with a heated forming tool such as a die face, the contact time with the foam is typically from about 0.1 second to about 60 seconds. Preferably, the dwell time is at least about 1 second to at most about 45 seconds.

When pressing with a heated forming tool such as a die face, the temperature of the die face is not so hot or held for too long a time such that the foam is degraded. Depending on the thermoplastic employed, the temperature of the die face is about 50° C. to about 200° C. Preferably, the temperature is at least about 60°, more preferably at least about 70° C., even more preferably at least about 80° C. and most preferably at least about 90° C. to preferably at most about 190°, more preferably at most about 180°, even more preferably at most about 170° C. and most preferably at most about 160° C.

The shape of the foam article is only limited by the ability to shape foam, a foam article, specifically a shaped foam article may have one or more surfaces, for example if the shaped foam article is a sphere it would have a single surface. More complex shaped foam articles will have more than one surface, for example if the shaped foam article is a bowling ball pin would have two surfaces, the continuous surface and the bottom of the pin. A rod would have three surfaces, a three sided pyramid or an extruded plank, four surfaces, a four sided pyramid, five surface, etc. Depending on the shape of the shaped foam article, it may have 1, 2, 3, 4, 5, 6, 7, 8, 9, 10 or more surfaces.

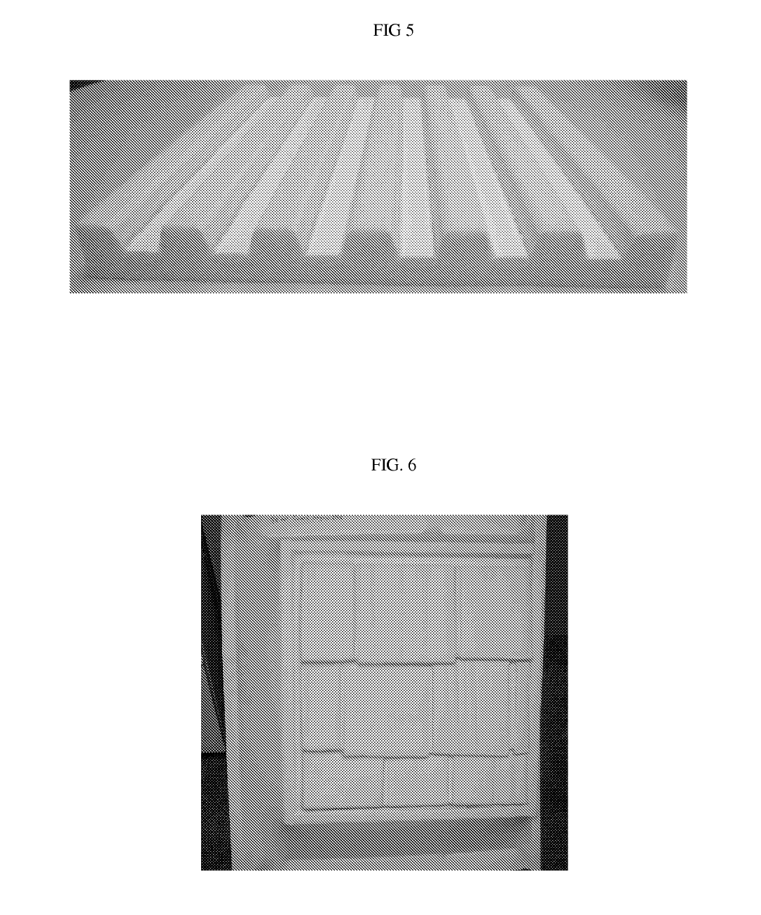

Transitions from one surface to another may be well defined, such as the six surfaces of a cube, or they may not be well defined, such as the surfaces of a complex shape such as the foam article shaped in the form of roofing shake shingles as shown in FIG. 5. A preferred shaped foam article is one in which the surface that the skin is vacuum formed onto is shaped and the opposite surface is flat, for example, if one surface (e.g., the plank's top surface) of a foam plank is shaped the opposing surface (e.g., the plank's bottom surface) is not, see FIG. 6.

The skin of the present invention can be any material capable of being vacuum formed. Vacuum forming is well known. As the name implies, vacuum forming is the forming or shaping of a material by the application of pressure wherein the pressure is brought about by a vacuum on one side of the material. Depending on the composition of the material, typically, heat is also applied. Any material capable of being vacuum formed is suitable for the skin of the present invention. For example, the skin may comprise a thermoset sheet, a metal film, wood venire, glass, cloth, fiber mat, ceramic, leather, inflammable coatings, and the like. Preferably, the skin is a sheet comprising a thermoplastic polymer. Skin materials can be used independently or in combinations or mixtures thereof, for instance a suitable skin may be a coextruded sheet having 2 or more (3, 4, 5, 6, 7, 8, 9, 10, etc.) thermoplastic layers which may be of the same or different thermoplastic materials or the skin could be a laminate of different materials such as a fabric and leather or a metal film and a thermoplastic sheet. By convention, material equal to or greater than 1 mm thick is called sheet or sheeting and material less than 1 mm thick is called film.

Any thermoplastic polymer is suitable for use as skins in the present invention. Preferably the skin of the present invention comprises polystyrene (PS); high impact polystyrene (HIPS); styrene and acrylonitrile copolymer (SAN); acrylonitrile, butadiene, and styrene terpolymer (ABS); polyphenyleneoxide sometimes referred to as polyphenylenether (PPO or PPE); polycarbonate (PC); polyester (PES) such as polyethylene terephthalate (PET) or polybutylene terephthalate (PBT); polyethylene (PE) including homopolymers of PE or copolymers of PE with a C₃ to C₂₀ alpha-olefin, high density polyethylene (HDPE), low density polyethylene (LDPE), linear low density polyethylene (LLDPE), substantially linear ethylene polymer (SLEP), linear ethylene polymer (LPE); polypropylene (PP) such as a homopolymer of PP or a copolymer, for example, a random or block copolymer, of PP and an alpha-olefin, preferably a C₂ or C₄ to C₂₀ alpha-olefin; thermoplastic polyolefin (TPO); olefinic thermoplastic elastomer (TPE); chlorinated polyethylene (CPE); polyvinyl chloride (PVC); polytetrafluoroethane (PTFE); polyurethane (PU); thermoplastic polyurethane (TPU); polyacrylate such polyacrylic acid (PAA), polybutyl acrylate (PBA), polymethacrylate (PMA), polymethyl methacrylate (PMMA) polyamide (PA); and blends thereof, for example PC/ABS.

The form of the thermoplastic skin used in the present invention can be a film or a sheet. The film or sheet may be mono layered or coextruded having multiple layers, i.e., 2, 3, 4, 5, 6, 7, 8, 9, 10, or more layers. If a coextruded sheet is used, one or more layers may be foamed.

The thermoplastic polymer used as the skin of the present invention may contain additives, typically dispersed within thermoplastic polymers. Common additives include any one or combination of more than one of the following: infrared attenuating agents (for example, carbon black, graphite, metal flake, titanium dioxide); clays such as natural absorbent clays (for example, kaolinite and montmorillonite) and synthetic clays; nucleating agents (for example, talc and magnesium silicate); fillers such as glass or polymeric fibers or glass or polymeric beads; flame retardants (for example, brominated flame retardants such as brominated polymers, hexabromocyclododecane, phosphorous flame retardants such as triphenylphosphate, and flame retardant packages that may including synergists such as, or example, dicumyl and polycumyl); lubricants (for example, calcium stearate and barium stearate); acid scavengers (for example, magnesium oxide and tetrasodium pyrophosphate); UV light stabilizers; thermal stabilizers; and colorants such as dyes and/or pigments.

The shaped foam article is perforated by any acceptable means to provide sufficient vacuum through the article to allow vacuum forming the skin onto part of one, one, or more of its surfaces. The shaped foam article has a plurality of perforations. The perforations extend through the shaped foam article, for instance for a shaped foam article made from a foam plank, through the depth of the foam plank so as to allow a vacuum to be pulled through the shaped foam article. Perforating the foam article may comprise puncturing the foam article with a one or more of pointed, sharp objects in the nature of a needle, pin, spike, nail, or the like. However, perforating may be accomplished by other means than sharp, pointed objects such as drilling, laser cutting, high-pressure fluid cutting, air guns, projectiles, or the like. The perforations may be made in like manner as disclosed in U.S. Pat. No. 5,424,016, which is hereby incorporated by reference.

In the process of the present invention a perforated shaped foam article is placed into a fixture equipped with a means to pull a vacuum, for example a vacuum inlet port. Vacuum is pulled through the perforations of the perforated shaped foam article of the invention. The fixture may be flat or contoured to match one or more surface of the shaped foam article. The surface or surface(s) of the perforated shaped foam article that fit within the fixture is/are the surface(s) which the skin is not vacuum formed onto. In other words, at least part of one surface, one surface, or more than one surface of the shaped foam composite article of the present invention is not covered by the vacuumed formed skin (this is referred to as the non-skin-bonded surface(s)). Moreover, in the process of the present invention, a part of one surface, one surface, or more than one surface of the shaped foam article is vacuum formed with a skin to produce the shaped foam composite article of the invention (this is referred to as the skin-bonded surface(s)). Preferably the vacuum pressure is at least 5 psi, more preferable at least 7 psi and most preferable 10 psi or greater. Preferably, the vacuum duration is less than 1 second and most preferably less than at least 2 seconds.

When the skin is one or more thermoplastic sheet, one or more coextruded sheet, or combinations thereof sufficient heat must be applies to soften the sheet forming a preheated sheet that may then be vacuumed formed onto the perforated shaped foam article. The temperature will vary depending on the thermoplastic employed; however a suitable temperature is preferably near, at, or above the glass transition temperature (T_{g}) for the thermoplastic sheet being vacuum formed.

Means are well known to one of ordinary skill in the art to clamp, heat, and maneuver the softened thermoplastic sheet into the desired position relative the fixture comprising the perforated shaped foam article to allow vacuum forming the preheated sheet onto the perforated shaped foam article. The fixture comprising the perforated shaped foam article and the softened thermoplastic sheet are mated, for example by hydraulic actuation of the fixture into the preheated thermoplastic sheet, and sufficient vacuum is applied to draw the preheated thermoplastic sheet against the surface(s) of the perforated shaped foam article forming a shaped foam composite article of the present invention. The shaped foam composite article is allowed to cool and removed from the fixture, FIG. 6. If necessary, any excess skin is trimmed from the shaped foam composite article.

Preferably the skin is bonded directly to the shaped foam article, in other words with no intervening layer of material. Adhesion between the skin and shaped foam article may result from one or a combination of more than one of the following mechanisms: thermal, mechanical, physical, or chemical. For example, adequate adhesion between the skin and the shaped foam article may result from thermal compatibility (i.e., heated polymer strands of the skin intermingle with heated polymer strands of the shaped foam article forming a melt bond), physical compatibility (i.e., heated polymer strands of the skin are drawn into the cellular structure of the shaped foam article forming mechanical bonds), pressured engagement, fusion bonding, combinations thereof, and the like. The sheet can also be conformed to the surface of the shaped foam and then adhered with mechanical means such as clips, fasteners and the like.

However, in the case of non-thermoplastic skins (e.g., thermoset sheet, a metal film, wood venire, cloth, fiber mat, leather, and the like) and/or non-thermoplastic foams (i.e., thermoset), and/or when the skin is a thermoplastic sheet but where thermal and mechanical bonds are inefficient to provide adequate bonding between it and the shaped foam article an adhesive may be employed between the skin and the shaped foam article. Any adhesive capable of bonding a specific shaped foam article/skin combination is within the scope of the present invention. An effective type and amount of adhesive can be determined by one of ordinary skill in the art without undue experimentation for a given skin/foam combination.

Not to be limited to the following adhesives, a suitable adhesive may be a compound (e.g. a chemical adhesive which, for example can be a one part or multiple part adhesive), a film such as double sided tape, or another layer or film comprising a material which is compatible with (i.e., bonds to) both the foam of the shaped foam article and the skin such that when the two are vacuum formed the film bonds the two together.

Suitable materials for use as adhesives or in adhesive layers include those adhesive materials known in the art as useful with plastic films and foams, see U.S. Pat. No. 5,695,870, which is hereby incorporated by reference. Examples include polyolefin copolymers such as ethylene/vinyl acetate, ethylene/acrylic acid, ethylene/n-butyl acrylate, ethylene/methylacrylate, ethylene ionomers, and ethylene or propylene graft anhydrides. Other useful adhesives include urethanes, copolyesters and copolyamides, styrene block copolymers such as styrene/butadiene and styrene/isoprene polymers, acrylic polymers, and the like. The adhesives may be thermoplastic or curable thermoset polymers, and can include tacky, pressure-sensitive adhesives. The adhesive or adhesive layer is preferably recyclable within the foam board manufacturing process. The adhesive material must not negatively impact the physical integrity or properties of the foam to a substantial degree.

For example, suitable adhesives are foam craft adhesives such as 3M Styrofoam Spray Adhesive, adhesives based on dispersions, e.g. ACRONAL™ Acrylate Dispersions available from BASF, one-component polyurethane adhesive such as INSTASTIK™ available from The Dow Chemical Company, hot-melt adhesives, moisture-cured adhesives such as those described in U.S. Pat. No. 7,217,459B2, which is hereby incorporated by reference, single- or preferably two-component adhesives based on polyurethane resins or on epoxy resins, see USP 20080038516A1, which is hereby incorporated by reference, and the like.

Prior to vacuum forming the skin to the shaped foam article, the adhesive can be applied to the skin-bonding surface of the shaped foam article, the skin-bonding surface of the skin, or both the skin-bonding surface of the shaped foam article and the skin-bonding surface of the skin. The adhesive may be automatically or manually applied by any means, such as spraying, brushing, robotically dispensing, dipping, pouring, positioning, sticking, etc.

In one embodiment of the present invention, adhesion between the skin to the shaped foam article may be enhanced if the bonding surface of the shaped foam article is rough, for example the shaped foam article is formed in a textured tool, or the bonding surface prior to adhesion may be abraded (e.g., with a rasp, file, sandpaper, or the like), scratched, sand blasted, particle blasted, or the like.

The process of the present invention comprises the steps of (i) providing a perforated shaped foam article and (ii) vacuum forming a skin onto the perforated shaped foam article to provide a shaped foam composite article. The shaped foam article may be made by (1) directly foaming a shaped foam article or by (2) shaping an article from a foam plank by any suitable method, i.e., by abrasive wire cutting, hot wire cutting, die cutting, water jet cutting, milling, match mold thermoforming, continuous role forming compression, or combinations thereof. The order of the steps regarding (a) shaping and (b) perforating the foam article is not important as long as the shaped foam article is adequately perforated prior to the vacuum forming step. For instance, a first embodiment of the method of the present invention is to form a shaped foam article then perforate it to provide a perforated shaped foam article, another embodiment of the method of the present invention is to shape a foam article from a foam plank then perforate the shaped foam article to provide a perforated shaped foam article, yet another embodiment of the method of the present invention is to perforate a foam plank and then shape the perforated foam plank to provide a perforated shaped foam article.

### Example

About 5 millimeters (mm) layer is removed by planing from the top and the bottom of an IMPAXX™ 300 Foam Plank, available from The Dow Chemical Co., Midland, Mich. This foam plank is an extruded polystyrene foam with dimensions measuring 110 mm by 600 mm by 2,200 mm in the thickness, width and length directions respectively. The planed plank is perforated using an offline perforator equipped with a series of 2.0 mm diameter needles approximately 8.5 inches (in.) in length. The needles are spaced approximately 0.5 in. apart and the frequency of the perforation machine was set at approximately 20 Hertz (Hz), resulting in a rectangular perforation pattern of 0.5 in. by 0.75 in. to the foam plank. The plank is fed lengthwise through the perforator, thus, the 0.5 in. spacing is imposed to the width direction of the plank whereas the 0.75 in. spacing is imposed to the length direction of the plank, respectively.

Next, the perforated IMPAXX 300 Foam Plank is cut to render a foam blank measuring approximately 20 in. by 20 in. by 2 in., in the length, width and thickness directions respectively. The cut, or core, surface of the foam blank is then compressed against the surface of a prototype cast tool in the shape of shake shingles at ambient temperature until the upper platen contacted a series of 0.75 in. stop blocks. Once the stop blocks are contacted, the platens are opened and the perforated shaped foam article is removed from the surface of the casting tool. During the pressing, the foam is subjected to an applied strain of about 60 to about 65 percent.

The formed perforated shaped foam article is placed in a wooden fixture equipped with a vacuum inlet port on the base of the fixture. The skin comprises a 24 in. by 24 in. by 0.080 in. thick coextruded STYRON™ 1170 High Impact Polystyrene (HIPS) Resin. The coextruded sheet is a three layer structure (i.e., ABA) with solid skins (i.e., A layers) and the material in the center (i.e. B layer) foamed with a chemical blowing agent. The coextruded sheet is edge clamped and pre-heated to approximately 400° F. using an AVT shuttle thermoformer. Upon reaching the desired surface temperature, the sheet is shuttled over the perforated shaped foam article which is plunged vertically into the pre-heated sheet through the use of hydraulic actuation. Vacuum is applied and the pre-heated sheet is drawn against the formed part surface and allowed to cool with the use of multiple fans. Vacuum was applied at approximately 0.5 atmospheres (i.e. 7.3 psi) for 12 seconds. Chemical compatibility between the perforated shaped foam article and the thermoplastic skin results in exceptional adhesion at the foam-sheet interface. A photograph of the composite foam panel is shown in FIG. 6.

While certain embodiments of the present invention have been described in the preceding example, it will be apparent that considerable variations and modifications of these specific embodiments can be made without departing from the scope of the present invention as defined by a proper interpretation of the following claims.

1. A method to manufacture a shaped foam composite article comprising the steps of:
(i) preparing a shaped foamed article comprising a plurality of perforations and
(ii) vacuum forming a skin onto the perforated shaped foamed article.

2. The method of claim 1 wherein step (i) comprises:
(i)(a) producing a foam sheet,
(i)(b) perforating the foam sheet,
and
(i)(c) shaping the perforated foam sheet.

3. The method of claim 2 wherein the perforated sheet is shaped by wire cutting, hot wire cutting, die cutting, water jet cutting, milling, match mold thermoforming, continuous role forming, compression, or a combination thereof.

4. The method of claim 1 wherein step i) comprises:
(i)(a) producing a foam sheet,
(i)(d) shaping the foam sheet,
and
(i)(e) perforating the shaped foam sheet.

5. The method of claim 4 wherein the shaped foam sheet is shaped by wire cutting, hot wire cutting, die cutting, water jet cutting, milling, match mold thermoforming, continuous role forming, compression, or a combination thereof.

6. The method of claims 2 and 4 wherein the foam sheet (i)(a) comprises a foamed thermoplastic prepared by extrusion using a chemical blowing agent, an inorganic gas, an organic blowing agent, or combinations thereof.

7. The method of claims 2 and 4 wherein the foamed sheet comprises a thermoplastic polymer or a thermoset polymer.

8. The method of claim 7 wherein the thermoplastic polymer is polyethylene, polypropylene, copolymer of polyethylene and polypropylene; polystyrene, high impact polystyrene; styrene and acrylonitrile copolymer, acrylonitrile, butadiene, and styrene terpolymer, polycarbonate; polyvinyl chloride; polyphenylene oxide and polystyrene blend.

9. The method of claim 1 wherein the foam article comprises a foamed thermoplastic prepared by an expanded bead foam process.

10. The method of claim 1 wherein the foam article comprises a foamed thermoset polymer prepared by RIM.

11. The method of claim 1 wherein the skin is a thermoplastic sheet, thermoset sheet, a metal film, wood veneer, cloth, fiber mat, leather, or combinations thereof.

12. The method of claim 11 wherein the thermoplastic sheet is polystyrene; high impact polystyrene; styrene and acrylonitrile copolymer; acrylonitrile, butadiene, and styrene terpolymer; polyphenyleneoxide; polycarbonate; polyethylene terephthalate; polybutylene terephthalate; copolymers of PE with a C₃ to C₂₀ alpha-olefin, high density polyethylene, low density polyethylene, linear low density polyethylene, substantially linear ethylene polymer, linear ethylene polymer; polypropylene homopolymer; random copolymer of polypropylene; block copolymer of polypropylene; copolymer of propylene with a C₄ to C₂₀ alpha-olefin; thermoplastic polyolefin; olefinic thermoplastic elastomer; chlorinated polyethylene; polyvinyl chloride; polytetrafluoroethane; polyurethane; thermoplastic polyurethane; polyacrylic acid; polybutyl acrylate; polymethacrylate; polymethyl methacrylate; polyamide; and blends thereof.

13. The method of claim 1 wherein the skin adheres to the shaped foam article by thermal means, mechanical means, physical means, chemical means, adhesive means, or combinations thereof.

14. A shaped foam composite article made by the method of claim 1.
